(19) United States
(12) Patent Application Publication
(10) Pub. No.: US 2015/0004274 A1
(43) Pub. Date: Jan. 1, 2015

(54) 3D STRUCTURE SHAPING APPARATUS

(71) Applicant: HEISHIN LTD., Kobe-shi, Hyogo (JP)

(72) Inventor: Sumio Ono, Kobe-shi (JP)

(73) Assignee: Heishin Ltd., Kobe-shi, Hyogo (JP)

(21) Appl. No.: 14/373,337

(22) PCT Filed: Jan. 20, 2013
(86) PCT No.: PCT/JP2013/051013

§ 371 Date: Jul. 18, 2014

(30) Foreign Application Priority Data
Jan. 20, 2012 (JP) 2012-009567

(51) Int. Cl. B29C 67/00

(52) U.S. Cl. CPC B29C 67/0055
USPC 425/174.4; 425/375

(57) ABSTRACT

A three-dimensional (3D) structure shaping apparatus is provided with a material discharge pump having a uniaxial eccentric screw pump mechanism, and a table disposed opposite to the material discharge pump and for moving horizontally by a table moving device. The material discharge pump and a light-beam irradiation device are attached to a tip end of a robot arm. The robot arm and the table moving device are configured to relatively move the material discharge pump and the table. Thus, a degree of freedom in shaping the 3D structure is increased, enabling the fabrication of various kinds of 3D structures within a short period of time.

### TECHNICAL FIELD

The present invention relates to a three-dimensional (3D) structure shaping apparatus which can shape a 3D structure by laminating and curing a curing material, such as an ultraviolet curing resin.

### BACKGROUND ART

Conventionally, optical shaping apparatuses as disclosed in the following Patent Document 1 or Patent Document 2 are provided as apparatuses for shaping a 3D structure by laminating and curing resin, etc. The optical shaping apparatuses of the conventional arts can form a 3D structure by successively laminating a cured layer which is formed by irradiating a laser beam emitted based on data produced in advance, such as CAD-CAM data, onto an ultraviolet curing resin which is stored in a storage tub to cure the resin.

### REFERENCE DOCUMENTS OF CONVENTIONAL ART

### Patent Documents

Patent Document 1: JP2009-085570A

Patent Document 2: JP1994-315985A

### DISCLOSURE OF THE INVENTION

### Problems to be Solved by the Invention

The optical shaping apparatuses of the conventional arts described above are often used for applications such as producing prototypes of an industrial product during R&D stages. When producing a 3D structure for such applications, another prototype which is partially different in its configuration from a previously produced prototype may be needed as R&D activities progress.

However, there is a problem, in that the optical shaping apparatuses of the conventional arts described above have a low degree of freedom in shaping the 3D structures. Specifically, the optical shaping apparatuses of the conventional arts are to form the 3D structures by laminating a horizontal layer formed by irradiating ultraviolet rays from a translating light source onto the ultraviolet curing resin prepared in the storage tub. That is, the conventional arts are to form the three-dimensional (3D) structure by laminating two-dimensional (2D) layers formed by the irradiation of ultraviolet rays and, thus, the shaping is unidirectionally limited.

Furthermore, the optical shaping apparatuses of the conventional arts described above cannot reshape a previously produced 3D structure by additionally appending a part which later becomes needed. Therefore, when the optical shaping apparatuses of the conventional arts are used, one selects either an approach in which data, such as CAD-CAM data, for shaping the entire structure, including the appended part, is produced and the 3D structure is then integrally shaped, or an approach in which only the appended part is separately shaped, and the appended part is fixed with adhesive or the like onto the previously produced structure. If the former approach is applied, considerable effort and time may be required in order to obtain the prototype after the design change and, thus, R&D activities may be hindered. On the other hand, if the latter approach is applied, since the prototype is not integrally shaped, the structural strength may not be enough and hinder R&D activities. Therefore, the optical shaping apparatuses of the conventional arts have a low degree of freedom in shaping the 3D structures.

Furthermore, when producing the prototypes for R&D as described above, various prototypes must be produced. Thus, when the production of various kinds of 3D structures is needed within a short period of time, a faster shaping speed of the 3D structures is required. However, since the optical shaping apparatuses of the conventional arts require considerable time to shape the 3D structures, they cannot satisfy the need to produce various kinds of 3D structures within a short period of time.

Therefore, the purpose of the present invention is to provide a 3D structure shaping apparatus having a high degree of freedom in shaping a 3D structure and can produce various kinds of 3D structures within a short period of time.

### SUMMARY OF THE INVENTION

According to one aspect of the present invention, a three-dimensional structure (3D) shaping apparatus is provided, which includes a material discharge pump for being able to discharge curing material. The material discharge pump discharges the curing material based on a 3D shape of the 3D structure to be shaped. The 3D structure is shaped after the curing material is cured.

The 3D structure shaping apparatus of the present invention can shape the 3D structure by discharging the curing material from the material discharge pump based on the 3D shape of the 3D structure to be shaped. Therefore, the 3D structure shaping apparatus of the present invention can increase the degree of freedom in the shaping depending on the way in which the curing material is discharged from the material discharge pump.

Furthermore, the 3D structure shaping apparatus of the present invention can additionally shape another 3D structure onto an existing structure by discharging the curing material from the material discharge pump onto the existing structure, such as a previously produced 3D structure, and curing the curing material. Thus, the 3D structure shaping apparatus can also be used for shaping, such as a fine adjustment of the shape of the existing 3D structure, for example, like the case of a prototype production for R&D purposes. Furthermore, according to the 3D structure shaping apparatus of the present invention, a required part is integrally formed with the existing 3D structure to obtain a high-strength 3D structure.

The 3D structure shaping apparatus of the present invention can shape the 3D structure by successively curing the curing material discharged from the material discharge pump. Thus, the 3D structure shaping apparatus of the present invention can shape the 3D structure at a higher speed than the conventional arts where thin cured layers of the curing material are laminated in multiple layers.

In the three-dimensional structure shaping apparatus of the present invention, the material discharge pump is preferably to be comprised of a rotary displacement pump.

In the 3D structure shaping apparatus of the present invention, the material discharge pump is comprised of the rotary displacement pump. Thus, according to the 3D structure shaping apparatus of the present invention, the shaping accuracy of the 3D structure can be improved by accurately adjusting a discharge amount of the curing material.

In the three-dimensional structure shaping apparatus of the present invention, the curing material discharged by the material discharge pump is preferably to be cured by an irradiated light beam. The shaping apparatus is preferably to include a light-beam irradiation device for irradiating the light beam to cure the curing material. The focus of the light beam irradiated from the light-beam irradiation device is preferably to be in agreement with a discharge target location of the curing material by the material discharge pump.

According to this configuration, the curing material discharged from the material discharge pump can be reliably cured at a suitable location. Thus, the shaping accuracy of the 3D structure can be improved.

Furthermore, in the three-dimensional structure shaping apparatus of the present invention, the light-beam irradiation device is preferably to move together with the material discharge pump relatively to the table.

According to this configuration, it can prevent the focus of the irradiated light beam from the light-beam irradiation device from deviating from the discharge target location of the curing material by the material discharge pump. Thus, the shaping accuracy of the 3D structure can further be improved.

In the three-dimensional structure shaping apparatus of the present invention, the rotary displacement pump is preferably to pump the curing material by using a uniaxial eccentric screw pump mechanism having a male screw type rotor for eccentrically rotating by a driving force, and a stator having an inner circumferential surface formed in a female screw.

In the 3D structure shaping apparatus of the present invention, the material discharge pump is comprised of a pump provided with a uniaxial eccentric screw pump mechanism. Thus, in the 3D structure shaping apparatus of the present invention, the discharge amount and discharge pressure of the curing material can be adjusted accurately without causing pulsation, for example. Therefore, according to the 3D structure shaping apparatus of the present invention, the 3D structure can be shaped accurately into a desired shape.

The three-dimensional structure shaping apparatus of the present invention is preferably to include, as a moving mechanism for moving the material discharge pump, a manipulator having at least three or more degrees of freedom and able to move the material discharge pump.

According to this configuration, the material discharge pump is freely movable. Thus, the curing material can be discharged from various directions, and the degree of freedom in shaping the 3D structure can be further increased.

Furthermore, the 3D structure shaping apparatus of the present invention is preferably to include a material discharge pump for discharging the curing material, a table disposed opposite to a discharge port of the material discharge pump, and a moving mechanism for relatively moving the material discharge pump and the table. Furthermore, the moving mechanism is preferably to include a table moving device for moving the table.

According to the configurations, by moving the table freely with respect to the material discharge pump, the curing material can be discharged onto more exact locations based on the 3D shape of the 3D structure to be shaped and, thus, the degree of freedom in shaping the 3D structure can be increased further.

### Effects of the Invention

According to the present invention, the 3D structure shaping apparatus can be provided, in which the degree of freedom in shaping the 3D structure is high and various kinds of 3D structures can be produced within a short period of time.

### BRIEF DESCRIPTION OF DRAWINGS

FIG. 1 is a conceptual diagram illustrating a configuration of a 3D structure shaping apparatus according to one embodiment of the present invention.

FIG. 2 is a cross-sectional view illustrating a structure of a material discharge pump applied to the 3D structure shaping apparatus of FIG. 1.

FIG. 3 is a flowchart illustrating the operation of the 3D structure shaping apparatus of FIG. 1.

FIG. 4 is a perspective view illustrating a shaping process of a 3D structure by the 3D structure shaping apparatus of FIG. 1.

FIG. 5 is a perspective view illustrating the shaping process of the 3D structure by the 3D structure shaping apparatus of FIG. 1.

FIG. 6 is a perspective view illustrating a modification of the shaping method of the 3D structure by the 3D structure shaping apparatus of FIG. 1.

### MODES FOR CARRYING OUT THE INVENTION

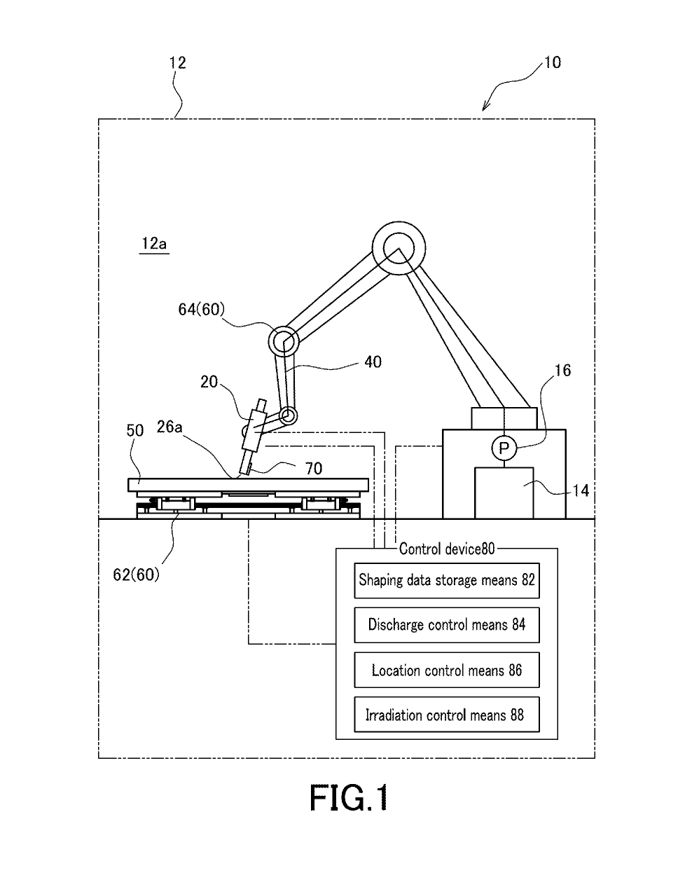

Next, a 3D structure shaping apparatus 10 (hereinafter, simply referred to as “the shaping apparatus 10”) according to one embodiment of the present invention is described in detail with reference to the accompanying drawings. As illustrated in FIG. 1, the shaping apparatus 10 is mainly comprised of a material discharge pump 20, a table 50, a moving mechanism 60, a light-beam irradiation device 70, and a control device 80. The shaping apparatus 10 discharges curing material toward the table 50 from the material discharge pump 20, while relatively moving the material discharge pump 20 and the table 50 by the moving mechanism 60. Furthermore, a light beam (ultraviolet rays) is irradiated onto the curing material, which is emitted from the light-beam irradiation device 70 to cure the material and thereby shape a 3D structure. Hereinafter, the configuration of each component which constitutes the shaping apparatus 10 and operation of the shaping apparatus 10 are described more specifically.

The material discharge pump 20 is disposed inside a shaping chamber 12a of a case 12, where light shielding is applied. The material discharge pump 20 pumps and discharges the curing material to be cured, which is prepared in a storage tank 14. In this embodiment, ultraviolet curing resin is used as the curing material. The material discharge pump 20 is comprised of a rotary displacement pump provided with a uniaxial eccentric screw pump mechanism (uniaxial eccentric screw pump).

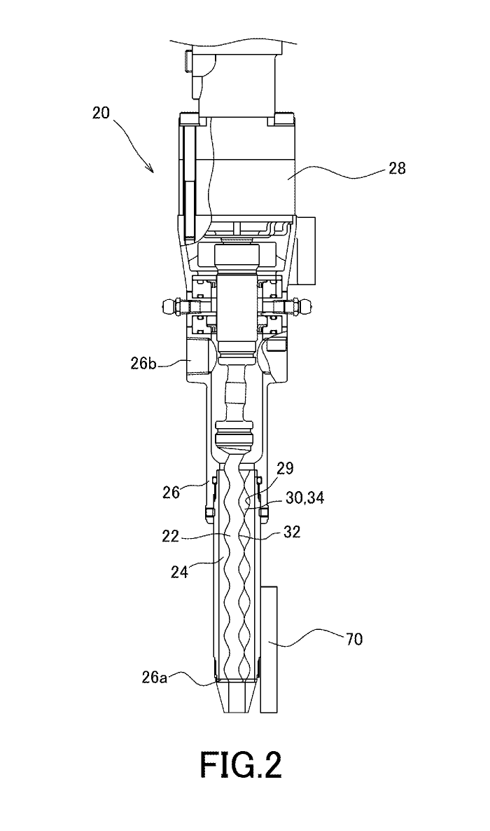

As illustrated in FIG. 2, the material discharge pump 20 has a male-screw-shaped rotor 22 which is eccentrically rotated by a driving force, and a stator 24 having an inner circumferential surface formed with a female screw. The material discharge pump 20 is configured so that the rotor 22 and the stator 24 are accommodated inside a pump case 26. The pump case 26 is a cylindrical member made of metal, and has an opening at one end side in the longitudinal direction, which functions as a discharge port 26a. An opening which functions as an introduction port 26b is formed in an intermediate part in the longitudinal direction of the pump case 26. The introduction port 26b is connected with a storage tank 14 by piping. Furthermore, a pump 16 for supplying the curing material to the material discharge pump 20 may be installed in a piping system which connects the material discharge pump 20 with the storage tank 14, if needed.

The material discharge pump 20 can suck the curing material to be pumped from the introduction port 26b and discharge the material from the discharge port 26a by rotating the rotor 22 in a predetermined direction. The stator 24 is a member having a substantially cylindrical appearance and shape formed from an elastic body or a resin, such as rubber. An inner circumferential wall 29 of the stator 24 is formed in a single-twist or multiple-twist female screw shape with n-grooves. In this embodiment, the stator 24 is formed in a multiple-twist female screw with two grooves. Furthermore, a penetration bore 30 of the stator 24 is formed so that the cross-section (aperture) thereof has a substantially elliptical shape even if the stator 24 is cut and viewed at any longitudinal cross-section of the stator 24.

The rotor 22 is a shaft body made of metal and is formed in a single-twist or multiple-twist male screw with n-1 grooves. In this embodiment, the rotor 22 is formed in an eccentric male screw with one groove. The rotor 22 is formed so that the cross section thereof is substantially circular even if the rotor 22 is cut and viewed at any longitudinal cross-section. The rotor 22 is inserted into the penetration bore 30 formed in the stator 24 described above to be freely and eccentrically rotatable inside the penetration bore 30. An end of the rotor 22 on the base end side thereof (introduction port 26b side) is connected with a motor 28, which is a source of the driving force, via a universal joint, etc. Therefore, the rotor 22 is rotated by the driving force from the motor 28.

When the rotor 22 is inserted into the stator 24, an outer circumferential wall 32 of the rotor 22 and the inner circumferential wall 29 of the stator 24 come into close contact with each other at their tangential lines, and a fluid transferring path 34 (cavity) is formed between the inner circumferential wall 29 of the stator 24 and the outer circumferential wall 32 of the rotor 22. The fluid transferring path 34 is formed so as to extend spirally in the longitudinal direction of the stator 24 and the rotor 22.

When the rotor 22 is rotated inside the penetration bore 30 of the stator 24, the fluid transferring path 34 advances in the longitudinal direction of the stator 24, while rotating inside the stator 24. Thus, the rotor 22 is rotated, the curing material is sucked into the fluid transferring path 34 from the storage tank 14 via a flow path 40 connected with one end side of the stator 24 (introduction port 26b side), and the curing material is transferred toward the other end side of the stator 24 in a state where the curing material is enclosed inside the fluid transferring path 34 and, thus, the curing material is dischargeable to the other end side of the stator 24 (discharge port 26a side).

Furthermore, the table 50 is disposed at a location which is opposite to the discharge port 26a of the material discharge pump 20. The table 50 is comprised of a plate body disposed horizontally, and is disposed inside the shaping chamber 12a where the light shields are applied in the case 12. The table 50 can move relatively to the material discharge pump 20 by the moving mechanism 60 described later in detail.

The moving mechanism 60 moves one or both of the material discharge pump 20 and the table 50 to relatively move them both. The moving mechanism 60 applied to this embodiment is comprised of a robot arm 62 (manipulator) for moving the material discharge pump 20, and a table moving device 64 for moving the table 50.

The robot arm 62 has at least three or more degrees of freedom, and the material discharge pump 20 is attached to a tip end part of the arm 62. Thus, the material discharge pump 20 is three-dimensionally movable with respect to the table 50. Furthermore, the table moving device 64 is comprised of a linearly guiding device (XY linear guide), and can move the table 50 smoothly and freely in a horizontal direction (X-Y directions) by the driving force from a driving source (not illustrated).

The light-beam irradiation device 70 is to irradiate ultraviolet rays to the curing material discharged toward the table 50 from the material discharge pump 20 and cure the curing material. The light-beam irradiation device 70 is attached to a tip end part of the robot arm 62 along with the material discharge pump 20. Furthermore, the light-beam irradiation device 70 is installed so that an optical axis thereof is oriented in the discharge direction of the curing material by the material discharge pump 20, and the focus of the ultraviolet rays matches with a discharge target location of the curing material.

The control device 80 is to control the operation of each part which constitutes the shaping apparatus 10, and is implemented inside a computer by installing control program(s). The control device 80 is comprised of a shaping data storage means 82, a discharge control means 84, a location control means 86, and an irradiation control means 88. The shaping data storage means 82 stores data for shaping a 3D structure (shaping data) inputted to the computer which constitutes the control device 80. The discharge control means 84 performs a discharge control of the curing material by the material discharge pump 20 described above. The discharge control means 84 can adjust a discharge amount of the curing material by performing a rotation control of the rotor 22.

The location control means 86 can control the relative location between the material discharge pump 20 and the table 50 by performing a motion control of the robot arm 62 and table moving device 64 which constitute the moving mechanism 60. Furthermore, the irradiation control means 88 controls an ultraviolet irradiation state by the light-beam irradiation device 70.

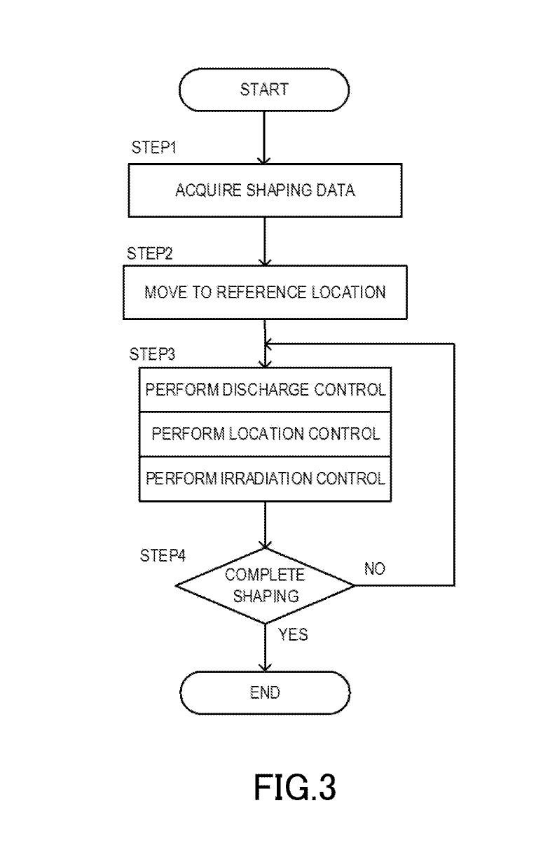

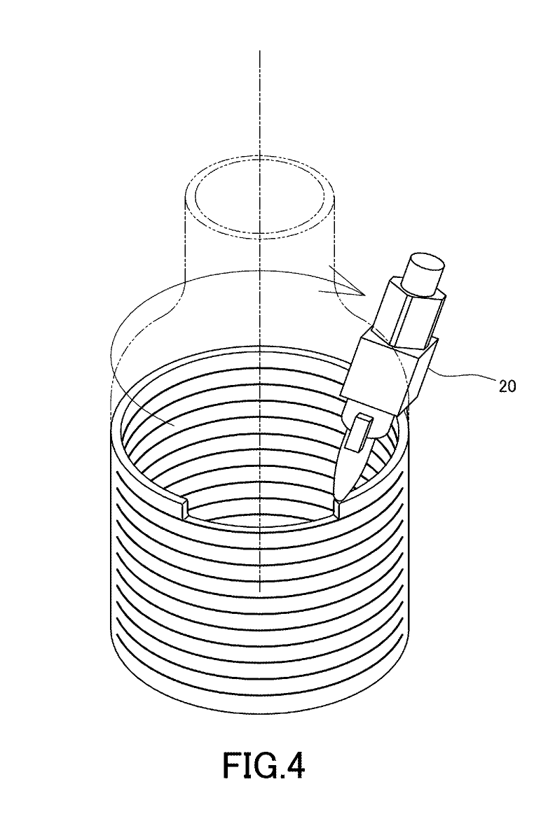

Next, the operation of the shaping apparatus 10 is described in detail with reference to, for example, a flowchart illustrated in FIG. 3. When shaping the 3D structure by the shaping apparatus 10, first at Step 1, the shaping data is acquired and stored in the shaping data storage means 82. Specifically, when shaping a bottle-shaped 3D structure as illustrated, for example, in FIG. 4, the shaping data according to this bottle is stored in the shaping data storage means 82. Then, at Step 2, the material discharge pump 20 and the table 50 move to a predetermined reference location under the control by the location control means 86. Then, the control flow transits to Step 3.

At Step 3, the motion control of each part is performed by the discharge control means 84, the location control means 86, and the irradiation control means 88 based on the shaping data stored in the shaping data storage means 82. Specifically, the discharge control means 84 performs a discharge amount control of the curing material based on the relative location of the material discharge pump 20 and the table 50, and the shaping data. The discharge amount control is performed by adjusting a rotation amount of the rotor 22 of the material discharge pump 20. Therefore, a suitable amount of the curing material for shaping the 3D structure is discharged toward the table 50.

The location control means 86 controls the location and the angle of the robot arm 62 and controls the location of the table moving device 64 (location control) based on the shaping data. Therefore, the curing material is discharged at a suitable location and at a suitable angle in order to produce the 3D structure. Furthermore, the irradiation control means 88 performs a control to operate the light-beam irradiation device 70 (irradiation control) during a period of discharging the curing material from the material discharge pump 20. Therefore, the curing material discharged onto the table 50 is cured by ultraviolet rays.

Specifically, when shaping the bottle-shaped 3D structure as illustrated in FIG. 4, the robot arm 62 is turned about on an axis L as illustrated by an arrow. Furthermore, the curing material is discharged from the material discharge pump 20, and the ultraviolet rays are irradiated from the light-beam irradiation device 70. Therefore, the discharged curing material is successively cured. Thus, as the material discharge pump 20, the robot arm 62, etc. are operated, the bottle-shaped 3D structure is gradually shaped.

Under the discharge control, the location control, and the irradiation control described above at Step 3, when the shaping of the 3D structure is started, it is examined whether the shaping of the 3D structure has been completed at Step 4. If the shaping of the 3D structure has not been completed at Step 4, the control flow is returned to Step 3, and the shaping of the 3D structure continues. On the other hand, if the shaping of the 3D structure has been completed, the discharge control, the location control, and the irradiation control are terminated and, thus, a series of motion controls is completed. Specifically, as illustrated by a two-dot chain line in FIG. 4, if an incomplete part exists, the control flow is returned from Step 4 to Step 3, and the shaping of the two-dot chain line part is performed. On the other hand, if shaping has been completed up to the part illustrated by the two-dot chain line, the discharge control, the location control, and the irradiation control are terminated because the shaping of the bottle as the 3D structure has been completed.

As described above, in the shaping apparatus 10, a 3D structure of a desired shape can be shaped by discharging the curing material, while relatively moving the material discharge pump 20 and the table 50 by using the moving mechanism 60. Furthermore, the robot arm 62 is adopted as the moving mechanism 60, and it is possible to three-dimensionally move the material discharge pump 20. Therefore, it is possible for the shaping apparatus 10 to discharge the curing material from various angles and various locations and, thus, there is a high degree of freedom in shaping.

Note that, although the example illustrated in this embodiment is a robot arm 62 which is adopted as the moving mechanism 60 for the material discharge pump 20 and the material discharge pump 20 which can move three-dimensionally, the present invention is not to be limited to this, and the material discharge pump 20 may also be two-dimensionally movable. Furthermore, although the example illustrated is a table moving device 64 which is driven two-dimensionally and adopted as the moving mechanism 60 for the table 50, the present invention is not limited to this, but an elevating device may also be provided in addition to the table moving device 64 described above to enable a three-dimensional drive. Furthermore, the moving mechanism 60 may be any kind of mechanism as long as it can relatively move the material discharge pump 20 and the table 50. Furthermore, either one of the robot arm 62 or the table moving device 64 may be configured to be omitted.

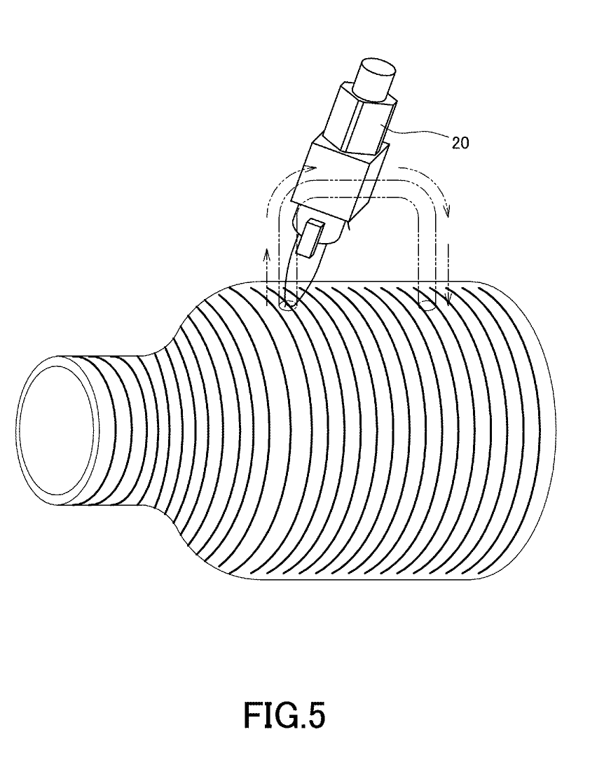

As illustrated in FIG. 5, in the shaping apparatus 10 of this embodiment, it is possible to place an existing structure, such as a 3D structure which has already been independently produced on the table 50, and to discharge the curing material from the material discharge pump 20 onto the structure and to cure the material. Therefore, a 3D structure can be additionally formed on the existing structure to permit shaping processing such as finely adjusting the shape. Thus, since a necessary part is integrally formed on the existing 3D structure, it is possible to obtain a 3D structure with high strength compared to a case where, for example, a separately-produced member is adhered to the existing 3D structure.

According to the shaping apparatus 10, it is also possible to define a sequence of shaping a plurality of parts which constitute a 3D structure and to shape the 3D structure in the order of the sequence per part. Alternatively, according to the shaping apparatus 10, as illustrated in FIG. 5, it is also possible to horizontally lay the part of the 3D structure (in the illustrated example, a container) formed in the standing posture as illustrated in FIG. 4, and to further shape another part (in the illustrated example, a handle) thereon.

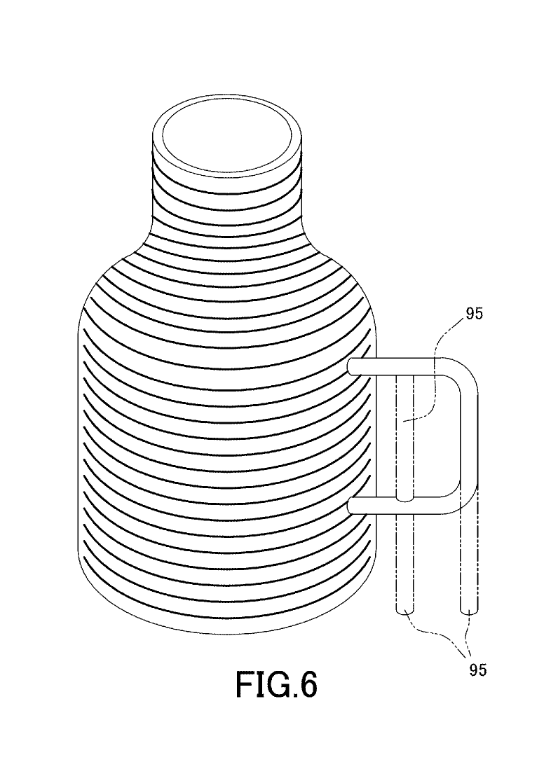

Here, when the 3D structure is shaped by the shaping apparatus 10, the strength of the shaped part (component) may not be enough until the curing material is cured. If, for example, there is a concern that the shaped part may deform before the curing material is cured and sufficient strength is demonstrated, a support part 95 for supporting the shaped part may be additionally produced together with the 3D structure to be produced, as illustrated by dashed lines in FIG. 6. Therefore, deformation can be avoided before the curing material is cured, and it is possible to produce the desired 3D structure by removing the support part 95 after the curing material is cured.

Since the shaping apparatus 10 described above is to shape the 3D structure by successively curing the curing material discharged from the material discharge pump 20, it can shape the 3D structure at high speed compared to a case like the optical shaping apparatuses of the conventional arts, where the thin cured layers of the curing material are laminated in multiple layers.

In the shaping apparatus 10, the material discharge pump 20 is comprised of the rotary displacement pump. Therefore, according to the shaping apparatus 10 of this embodiment, the discharge amount of the curing material can be adjusted accurately. Furthermore, since the material discharge pump 20 is particularly comprised of a pump provided with the uniaxial eccentric screw pump mechanism, pulsation of the discharge amount and discharge pressure of the curing material does not occur, for example. Therefore, according to the shaping apparatus 10, it is possible to accurately shape the 3D structure according to a design. Note that, in this embodiment, although an example in which a pump provided with the uniaxial eccentric screw pump mechanism is used as the material discharge pump 20 is illustrated, the present invention is not limited to this, but may also constitute a material discharge pump 20 with other types of rotary displacement pumps.

Since, in the shaping apparatus 10 described above, the light-beam irradiation device 70 is installed so that the focus of the light beam is in agreement with the discharge target location of the curing material by the material discharge pump 20, ultraviolet rays can be reliably irradiated onto the curing material discharged from the material discharge pump 20. Furthermore, since the light-beam irradiation device 70 is attached to the robot arm 62 together with the material discharge pump 20, the light-beam irradiation device 70 can follow the material discharge pump 20, while changing the location and the angle thereof. Therefore, in the shaping apparatus 10, it is possible to reliably cure the curing material discharged from the material discharge pump 20 and, thus, the 3D structure can be accurately shaped. Note that, in this embodiment, although the configuration in which the light-beam irradiation device 70 is attached to the robot arm 62 together with the material discharge pump 20 is illustrated, the present invention is not limited to this. Specifically, the light-beam irradiation device 70 may be installed, for example, on a different robot arm from the material discharge pump 20, and the light-beam irradiation device 70 may be configured to move to suitable locations so that the light-beam irradiation device 70 interlocks with the material discharge pump 20.

Although, in this embodiment, the example in which the ultraviolet curing resin is adopted as the curing material is illustrated, the present invention is not limited to this, and the material may be any kind of material as long as it can be cured after discharge from the material discharge pump 20. Specifically, it is possible to adopt resin, which can be cured by a light beam other than ultraviolet rays, such as thermosetting resin, sintering metal, as the curing material. Furthermore, if material other than the ultraviolet curing resin is adopted as the curing material, it is desirable to install a suitable device to cure the curing material instead of the light-beam irradiation device 70. Specifically, if the thermosetting resin is adopted as the curing material, it is desirable to install a hot air generating device which can generate hot air. Furthermore, if the curing material that is used does not need a light beam or hot air to be cured, the shaping apparatus may be configured without the light-beam irradiation device 70 being provided.

### INDUSTRIAL APPLICABILITY

The 3D structure shaping apparatus of the present invention can be used suitably for creating a 3D object, which precisely follows a design, within a short period of time, using shaping data, such as CAD-CAM data. Furthermore, the 3D structure shaping apparatus of the present invention can be used suitably for integrally shaping, for example, a component onto the existing structure in order to finely modify a previously produced 3D structure.

### DESCRIPTION OF REFERENCE NUMERALS

10: Three Dimensional (3D) Structure Shaping Apparatus (Shaping Apparatus)
20: Material Discharge Pump
22: Rotor
24: Stator
50: Table
60: Moving Mechanism
62: Robot Arm (Manipulator)
64: Table Moving Device
70: Light-beam Irradiation Device
80: Control Device

1. A three-dimensional structure shaping apparatus comprising a material discharge pump for being able to discharge curing material, the material discharge pump discharging the curing material based on a three-dimensional shape of the three-dimensional structure to be shaped, the three-dimensional structure being shaped after the curing material is cured.

2. The three-dimensional structure shaping apparatus of claim 1, wherein the material discharge pump is comprised of a rotary displacement pump.

3. The three-dimensional structure shaping apparatus of claim 1, wherein the curing material discharged by the material discharge pump is cured by light beam being irradiated, and the shaping apparatus comprising a light-beam irradiation device for irradiating the light beam to cure the curing material, and
wherein the focus of the light beam irradiated from the light-beam irradiation device is in agreement with a discharge target location of the curing material by the material discharge pump.

4. The three-dimensional structure shaping apparatus of claim 3, wherein the light-beam irradiation device moves together with the material discharge pump.

5. The three-dimensional structure shaping apparatus of claim 2, wherein the rotary displacement pump pumps the curing material by using a uniaxial eccentric screw pump mechanism having a male screw type rotor for eccentrically rotating by a driving force, and a stator having an inner circumferential surface formed in a female screw.

6. The three-dimensional structure shaping apparatus of any one of claim 1, comprising, as a moving mechanism for moving the material discharge pump, a manipulator having at least three or more degrees of freedom and for moving the material discharge pump.

7. A three-dimensional structure shaping apparatus comprising a material discharge pump for being able to discharge curing material, the material discharge pump discharging the curing material based on a three-dimensional shape of the three-dimensional structure to be shaped, the three-dimensional structure being shaped after the curing material is cured, and the material discharge pump being comprised of a rotary displacement pump.

8. The three-dimensional structure shaping apparatus of claim 7, wherein the curing material discharged by the material discharge pump is cured by light beam being irradiated, and the shaping apparatus comprising a light-beam irradiation device for irradiating the light beam to cure the curing material, and
wherein the focus of the light beam irradiated from the light-beam irradiation device is in agreement with a discharge target location of the curing material by the material discharge pump.

9. The three-dimensional structure shaping apparatus of claim 8, wherein the light-beam irradiation device moves together with the material discharge pump.

10. The three-dimensional structure shaping apparatus of claim 7, wherein the rotary displacement pump pumps the curing material by using a uniaxial eccentric screw pump mechanism having a male screw type rotor for eccentrically rotating by a driving force, and a stator having an inner circumferential surface formed in a female screw.

11. The three-dimensional structure shaping apparatus of claim 7, comprising, as a moving mechanism for moving the material discharge pump, a manipulator having at least three or more degrees of freedom and for moving the material discharge pump.

12. A three-dimensional structure shaping apparatus comprising a material discharge pump for being able to discharge curing material, the material discharge pump discharging the curing material based on a three-dimensional shape of the three-dimensional structure to be shaped, the three-dimensional structure being shaped after the curing material is cured,
wherein the curing material discharged by the material discharge pump is cured by light beam being irradiated, and the shaping apparatus comprising a light-beam irradiation device for irradiating the light beam to cure the curing material, and
wherein the focus of the light beam irradiated from the light-beam irradiation device is in agreement with a discharge target location of the curing material by the material discharge pump.

13. The three-dimensional structure shaping apparatus of claim 12, wherein the material discharge pump is comprised of a rotary displacement pump.

14. The three-dimensional structure shaping apparatus of claim 12, wherein the light-beam irradiation device moves together with the material discharge pump.

15. The three-dimensional structure shaping apparatus of claim 12, wherein the rotary displacement pump pumps the curing material by using a uniaxial eccentric screw pump mechanism having a male screw type rotor for eccentrically rotating by a driving force, and a stator having an inner circumferential surface formed in a female screw.

16. The three-dimensional structure shaping apparatus of claim 12, comprising, as a moving mechanism for moving the material discharge pump, a manipulator having at least three or more degrees of freedom and for moving the material discharge pump.
